(19) United States
(12) Patent Application Publication
(10) Pub. No.: US 2017/0080841 A1
(43) Pub. Date: Mar. 23, 2017

(54) Keel Guide

(71) Applicant: Jeffrey Allen Eigenheer, Hudson, WI (US)

(72) Inventor: Jeffrey Allen Eigenheer, Hudson, WI (US)

(21) Appl. No.: 14/859,297

(22) Filed: Sep. 19, 2015

(51) Int. Cl. B60P 3/10

(52) U.S. Cl. CPC B60P 3/1066

(57) ABSTRACT

A positive placement boat centering guide that is easily and quickly attached to a boat trailer to guide a boat directly in the center line of the trailer while loading and unloading. This device holds a keel roller up high enough to make contact with the bottom keel center of a boat as soon as it starts entering the trailer for loading. And lowers as the trailer is pulled out of the water, all the while holding the boat in the direct center of the trailer. Thus allowing a single person to pull the boat out of the water without the need for a second person. The boat is loaded and unloaded without the need to do anything unusual or special.

### BACKGROUND OF THE INVENTION

I have always had trouble getting my boat to load correctly in the center of my trailer. Especially when I am by myself. Which is fairly often. Every boat has “Keel Rollers,” mounted in a fixed position just behind the metal trailer frame to keep the boat from ever possibly hitting the trailer frame and damaging the boat hull. These fixed keel rollers are very important and must not be moved. But the problem with fixed keel rollers is when the trailer is backed fully into the water for loading, these keel rollers are way too far down from the water surface to ever touch the boat. So the back of the boat is floating freely from side to side when attached to the trailer at the bow with a strap. When the trailer is pulled out of the water, the boat settles on the trailer bunks (That support the weight of the boat) in whatever position the boat floats to. Not usually in the center of the trailer. This can cause damage to the sides or bottom of the boat even if this is noticed right away.

I tried other products for guiding the boat on the trailer, but still had problems with the boat rubbing on one side or the other. The problem with the other “Guide-On's” is that they only provide a bumper for the boat so it can't go too far over. But you still do not want to possibly cause damage by touching those guides.

### BRIEF SUMMARY OF THE INVENTION

Most boats have a ridge bump running down the bottom center of the boats keel. The fixed keel rollers installed by the trailer manufacturers are placed just behind and slightly higher than the trailer frame to protect the boat hull from damage caused by the trailer frame. Some fixed keel rollers have a center groove in them to help guide the boat on and off the trailer. But when the trailer is backed fully into the water for loading and unloading, the floating boat hull is several inches above the fixed keel rollers mounted firmly on the trailer frame.

So I invented a way to put these keel rollers on a pivoting spring loaded arm that will be raised up when the boat is not on the trailer, and make contact with the bottom center of the boat as soon as the boat begins to enter the trailer. The contact with the boat hull forces the “Keel Guide” arm forward and down but held firmly from moving side to side never loosing contact with the boat. The center bottom keel of the boat rests in the center v-shaped groove in the keel roller and helps to guide the boat on and off the trailer. The “Keel Guide” also holds the boat in place while the trailer is pulled out of the water thus eliminating the need for a second person to center the boat on the trailer. Keel rollers have been around forever, some trailers have multiple roller bunks designed to carry the weight of the boat and help center the boat while loading. Those trailers would have no need for my invention. My invention is for trailers equipped with solid carpeted bunks that support the weight of the boat.

The “Keel Guide” will also work with “Boat Lifts” by holding the boat in the correct position while it is raised and lowered.

Keel Guide description

Positive placement Boat centering keel roller guide-on.

Purpose

To hold the boat in the vertical center of the trailer while loading and unloading.

How Keel Guide Operates

The mounting bracket is attached directly in the center of the boat trailer on the front side of one of the cross frame members of the trailer running parallel with the axel. The swing arm is mounted to the bracket on the front side. The springs will hold the swing arm in the “UP” position until the boat makes contact with the keel roller as it enters the trailer and forces the swing arm forward and down. This direct contact with the bottom of the boat will hold the boat in the center of the trailer until the trailer is pulled out of the water, and the boat comes to rest on the bunks of the trailer. Once the “Keel Guide” is mounted on the trailer or lift, you load and unload a boat the same way as you did before.

### BRIEF DESCRIPTION OF THE SEVERAL VIEWS OF THE DRAWING

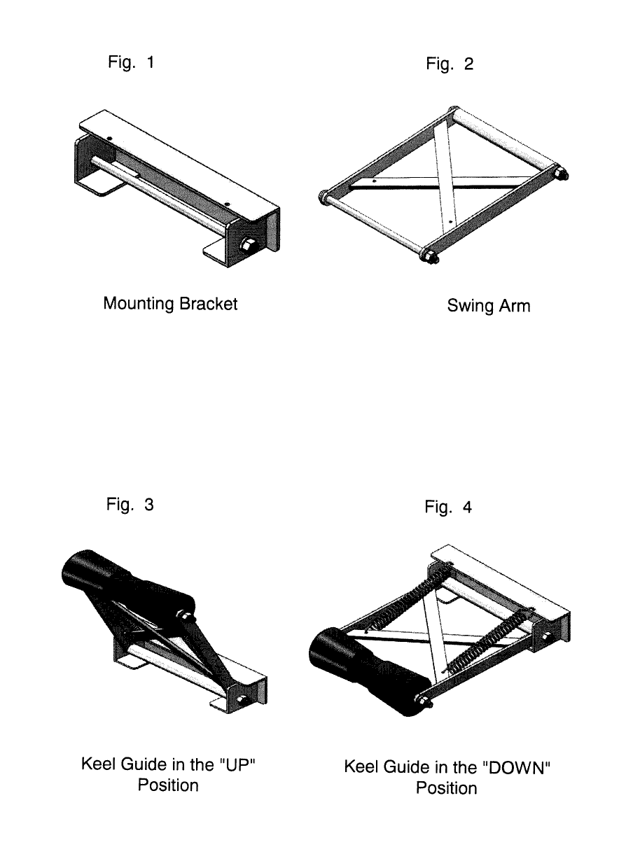

(FIG. 1) The mounting bracket holds the arm in the correct location on the trailer frame.

(FIG. 2) The swing arm freely pivots on the mounting bracket and is held in the up position by springs or similar device.

(FIG. 3) The mounting bracket also prevents the swing arm from going up too far.

(FIG. 4) Shows the lowest position if the springs where to malfunction. The swing arm is forced forward and down by the boat as it enters the trailer all the while keeping contact with the bottom keel of the boat.

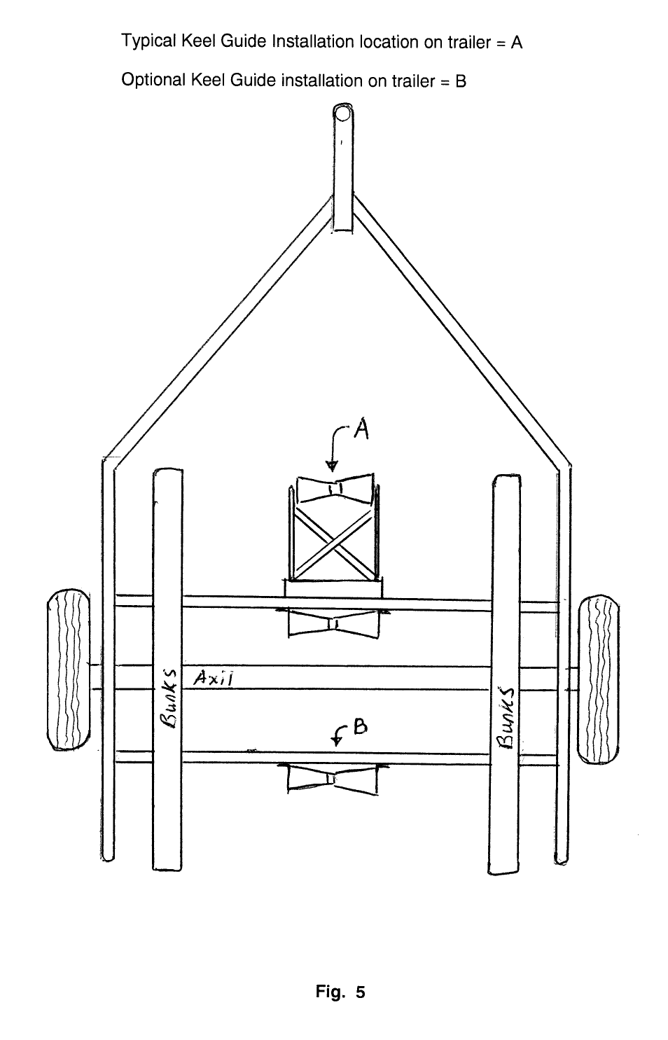

(FIG. 5) shows the typical location for mounting the Keel Guide to the boat trailer frame.

What is claimed is:

1. In combination with the conventional keel rollers mounted on the boat trailers for protecting the boat from hull damage, an apparatus for centering and holding a boat on a trailer comprising a rigid elongated bracket adapted to be attached to the trailer chassis frame directly centered on the front side of a trailer frame member running parallel with the axel on said trailer.

2-3. (canceled)

4. A pivoting arm like second member attached to said bracket that holds a free spinning keel roller attached horizontally on the top side of said arm in the exact center of said trailer which arcs freely front to back, up and down, but not side to side and is held in the “UP” position by springs or similar devices.

5. (canceled)

6. The above bracket also provides for a set range of motion for the above arms movement to prevent possible harm to the boat or trailer should any part fail.

7. Above said arm holds the roller in the up position until the boat makes contact while loading and the arm is then forced forward and down, never loosing contact with the bottom of the boat.

8. (canceled)

9. The Keel Guide could also be used for holding boats in the center of fixed boat lifts designed to raise and lower boats at a dock.
